(19) United States
(12) Patent Application Publication
(10) Pub. No.: US 2020/0343850 A1
(43) Pub. Date: Oct. 29, 2020

(54) SOLAR PANEL SUPPORT

(71) Applicant: LS ELECTRIC CO., LTD., Anyang-si, Gyeonggi-do (KR)

(72) Inventors: Seungpil YANG, Anyang-si, Gyeonggi-do (KR); Changsub WON, Anyang-si, Gyeonggi-do (KR)

(21) Appl. No.: 16/767,938

(22) PCT Filed: Nov. 12, 2018
(86) PCT No.: PCT/KR2018/013705

§ 371 Date: May 28, 2020

(30) Foreign Application Priority Data
Nov. 30, 2017 (KR) 10-2017-0162395
Nov. 30, 2017 (KR) 10-2017-0162396

(51) Int. Cl. H02S 10/40; B63B 35/44; H02S 30/10

(52) U.S. Cl. CPC H02S 10/40; B63B 2035/4453; H02S 30/10; B63B 35/44

(57) ABSTRACT

The present invention has been devised to solve the problem mentioned above and a purpose thereof is to provide a solar panel support having a buoyant body, which has excellent buoyancy retention, enables easy maintenance, and even during maintenance, can maintain maximum supportability. A solar panel support according to one aspect of the present invention comprises a buoyant body for supporting a solar panel, wherein the buoyant body comprises: a parent buoyant body including a coupling hole formed therethrough; and a child buoyant body detachably and fittedly inserted to the coupling hole.

### BACKGROUND

### 1. Technical Field

The present disclosure relates to a solar panel support, and more particularly, to a solar panel support applied to a solar power generation system.

### 2. Description of the Related Art

In general, a solar power generation system (device) is a device that converts photovoltaic energy into electric energy using a solar cell to generate electricity.

These solar power generation systems have been installed on the ground or on the roof of buildings in the past, but the number of cases installed on the water surface has increased in consideration of securing the site and the efficiency of the power generation device. When a solar power generation device is installed on the water surface, there are advantages such as reduction in compensation and cost issues associated with site acceptance, reduction in friction with residents, and increase in power generation efficiency due to cooling effect by water.

Of course, in the case of a floating solar power generation device, a buoyant body or a mooring device is required to float and support a solar panel on the water surface, and there are also some additional problems to be solved, such as securing space and increasing construction costs, but it has relatively large advantages, and its use is expanding.

In summary, a floating solar power generation system has a lower ambient temperature than that of a system installed on the land, so it has the advantages of high power generation efficiency, eco-friendliness, and low friction with residents, so its installation is increasing.

In the case of a floating power generation device, a solar panel is installed on the water surface, so a buoyant body is inevitably required to float and support it. There are two types of buoyant bodies, such as a mechanical type (frame type) buoyant body and a buoyancy integral type buoyant body.

First, a mechanical (frame type) buoyant body is mainly applied to a place with deep depth, large water-level change, high wind speed and high flow rate. Therefore, the mechanical buoyant body has excellent resistance and safety against strong winds, tides, and waves. In addition, when the buoyant body is broken, there is also an advantage of maintaining buoyancy with an internal filler. Since the mechanical buoyant body has high structural stability, it may maintain a high inclination angle (above 30 degrees) of the solar panel, thereby providing relatively high power generation efficiency. However, there is a disadvantage that the construction cost is relatively high. In the case of the mechanical buoyant body, the material of the buoyant body is typically made of a metal material such as an aluminum-zinc-magnesium alloy.

Next, the buoyancy integral type buoyant body is applied to a place where water level change, flow rate or wind speed is low, such as a reservoir or pond. The buoyancy integral type buoyant body may be constructed quickly and conveniently, and has the advantage of being economical due to low construction cost. In the case of the buoyancy integral type buoyant body, the solar module has a relatively low inclination angle, and thus power generation efficiency is slightly lower than the mechanical buoyancy type buoyant body. In the case of the buoyancy integral type buoyant body, the material of the buoyant body is typically made of synthetic resin such as PE (polyethylene).

It is as described above that the buoyant body is essential to float and support the solar panel in the floating solar power generation device. In the mechanical type buoyant body, since the buoyant body is installed as a structure and a filler is injected therein, it is possible to respond and maintain for a considerable period of time even when part thereof is damaged.

However, in the buoyancy integral type buoyant body, even when a separate buoyant body is used for each solar panel, or buoyant bodies are connected by a frame, the influence of the buoyant body appears immediately, the influence of the buoyant body immediately appears, and thus when the buoyant body is damaged, maintenance such as immediate replacement is required.

A solar panel support structure of a floating solar power generation device according to the prior art is illustrated in FIG. 1. A solar panel 1 is supported by a frame structure 2, and the frame structure 2 and the solar panel 1 are configured to float on the water surface by the buoyant body 3.

However, in the case of a buoyancy integral type solar panel support according to the related art, when the buoyant body 3 is damaged, the buoyant body 3 must be replaced as a whole and a lot of cost is required, and when the buoyant body 3 is removed for maintenance, a supporting force of the corresponding portion disappears and a temporary support structure corresponding thereto must be installed, thereby causing inconveniences.

### SUMMARY

The present disclosure is contrived to solve the foregoing problems, and an object of the present disclosure is to provide a solar panel support having a buoyant body that has excellent buoyancy retentivity, facilitates maintenance, and maintains the supporting force to the maximum even during maintenance.

A solar panel support according to an aspect of the present disclosure may include a buoyant body that supports the solar panel, wherein the buoyant body includes a parent buoyant body having a coupling hole disposed to pass therethrough; and a child buoyant body detachably and fittedly inserted to the coupling hole.

Here, a plurality of the coupling holes may be arranged in vertical and horizontal directions, and the child buoyant bodies may be coupled to the coupling holes, respectively.

Furthermore, the child buoyant body may be fittedly inserted to the coupling hole from a lower end of the parent buoyant body in an upward direction.

Furthermore, an upper surface of the child buoyant body may be exposed to an upper surface of the mother buoyant body through the coupling hole, and a lower portion of the child buoyant body may be exposed to a lower surface of the mother buoyant body.

Furthermore, the coupling hole may be tapered in a shape that narrows upward.

Furthermore, an upper portion of the child buoyant body may be inclined in a direction of decreasing upward, and a lower portion of the child buoyant body may be inclined in a direction of decreasing downward.

Furthermore, a diameter of a middle portion of the child buoyant body may be defined to be larger than that of the coupling hole.

Furthermore, an upper portion of the child buoyant body may be disposed to be in close surface contact with the coupling hole.

Furthermore, a frame coupling portion to which a structure frame connecting and supporting a plurality of buoyant bodies is coupled may be disposed at an upper portion of the child buoyant body.

Furthermore, the frame coupling portion may be defined in a ring shape.

Furthermore, a handle may be provided at a lower portion of the child buoyant body.

Furthermore, a cutout portion may be disposed at a side portion of the child buoyant body to reduce space.

Furthermore, child buoyant bodies coupled to the plurality of coupling holes, respectively, may be defined in different sizes.

In addition, the plurality of child buoyant bodies may be defined such that a size of the child buoyant body disposed at an outer edge portion is larger than that of the child buoyant body disposed at the center portion.

A solar panel support according to another aspect of the present disclosure may include a buoyant body that supports a solar panel, wherein the buoyant body includes a parent buoyant body having at least one coupling hole disposed to pass therethrough; a plurality of child buoyant bodies detachably coupled to the coupling holes, respectively; and a fastening member that fixes and supports the child buoyant bodies to the parent buoyant body.

Here, a mounting groove in which the fastening member is installed may be disposed in the parent buoyant body.

Furthermore, a fastening member coupling portion may be disposed to protrude from an upper portion of the child buoyant body, and an insertion hole may be disposed in the fastening member coupling portion to allow the fastening member to be fittedly inserted to the insertion hole.

Furthermore, the fastening member may include a body rod inserted into the insertion hole and a handle portion provided at an end portion of the body rod.

Furthermore, a restraining portion may be disposed to protrude from the body rod.

Furthermore, a first moving groove and a second moving groove allowing the restraining portion to move may be disposed in the mounting groove and the insertion hole, respectively.

Furthermore, an engaging portion may be disposed to protrude on the body rod to be spaced apart from the restraining portion.

Furthermore, a diameter of the engaging portion may be defined to be smaller than that of the restraining portion.

Furthermore, a restricting groove having a diameter smaller than that of the restraining portion and a diameter larger than that of the engaging portion may be disposed in the insertion hole.

Furthermore, the restraining portion and the engaging portion may be spaced apart from each other by 90 degrees based on a longitudinal axis of the body rod.

In addition, the restraining portion may be disposed to be placed behind the fastening member coupling portion in a normal state.

According to a solar panel support according to an aspect of the present disclosure, a buoyant body may include a parent buoyant body and a plurality of child buoyant bodies coupled thereto so as to divide buoyancy, thereby maintaining a certain degree of buoyancy even when there is damage to part thereof.

Furthermore, only the damaged part may be replaced, thereby facilitating maintenance and reducing replacement cost.

In addition, an additional retentivity support structure may not be required during maintenance work, thereby allowing simple and easy maintenance work.

Moreover, a child buoyant body may be defined in a streamlined shape to receive less resistance to wind or water, thereby maintaining a stable supporting force.

According to a solar panel support according to another embodiment of the present disclosure, a buoyant body may include a parent buoyant body and a plurality of child buoyant bodies coupled thereto so as to divide buoyancy, and thus even when there is damage to part thereof, a certain degree of buoyancy may be maintained.

The parent buoyant body and the child buoyant body may be stably supported because they are coupled to each other by a fastening member. They are easily detachable. Here, they are easily detachable since the fastening member is defined in a pin type. Therefore, maintenance work may be conveniently carried out. In addition, the fastening member may be disposed with a locking portion and thus not separated in a normal state.

The child buoyant body may be replaced only for the damaged part, thereby facilitating maintenance and reducing replacement cost.

In addition, an additional retentivity support structure may not be required during maintenance work, thereby allowing simple and easy maintenance work.

Moreover, the child buoyant body may be defined in a streamlined shape to receive less resistance to wind or water, thereby maintaining a stable supporting force.

### BRIEF DESCRIPTION OF THE DRAWINGS

FIG. 1 is a perspective view showing a solar panel support according to the related art.

FIG. 2 is a perspective view showing a solar panel support according to an aspect of the present disclosure.

FIG. 3 is a perspective view showing a buoyant body in FIG. 2.

FIG. 4 is a side view of FIG. 3.

FIGS. 5 and 6 are perspective and bottom plan views showing a parent buoyant body in FIG. 2.

FIG. 7 is a perspective view of a child buoyant body in FIG. 2.

FIG. 8 is a view illustrating another embodiment of a child buoyant body applied to a solar panel support according to an aspect of the present disclosure.

FIG. 9 is a view illustrating another embodiment of a buoyant body applied to a solar panel support according to an aspect of the present disclosure.

FIG. 10 is a perspective view showing a solar panel support according to another aspect of the present disclosure.

FIGS. 11 and 12 are perspective and plan views showing a buoyant body in FIG. 10, respectively.

FIG. 13 is a cross-sectional view taken along line A-A in FIG. 11.

FIG. 14 is an exploded perspective view of FIG. 10.

FIGS. 15 and 16 are perspective views showing a child buoyant body and a fastening member in FIG. 14.

FIG. 17 is a plan view according to another embodiment of a solar panel support according to another aspect of the present disclosure.

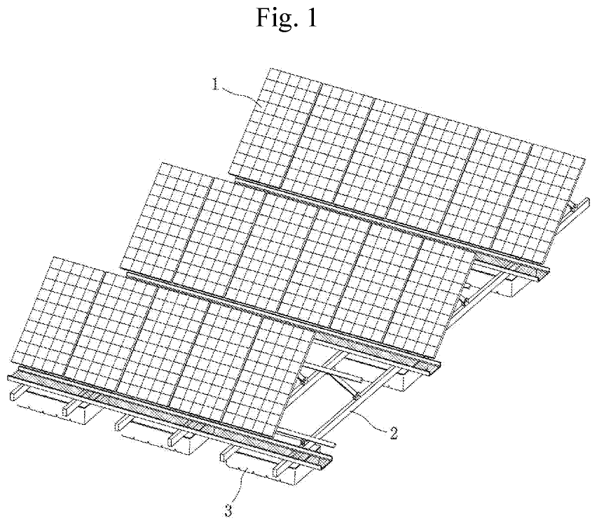

### DETAILED DESCRIPTION OF THE EMBODIMENTS

Hereinafter, preferred embodiments of the present disclosure will be described in detail with reference to the accompanying drawings to such an extent that the present invention can be easily implemented by a person having ordinary skill in the art to which the present invention pertains, and due to this, the technical concept and rights scope of the present invention is not limited thereto.

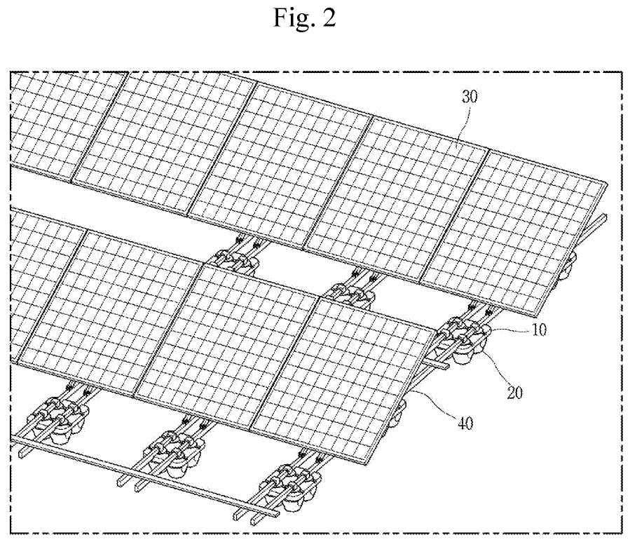

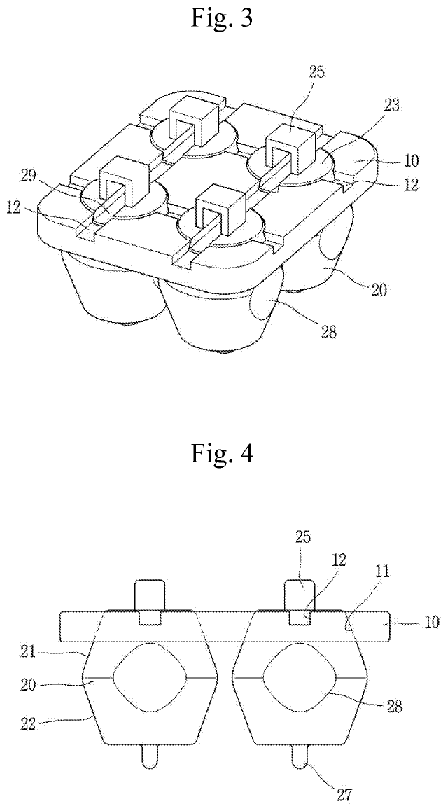

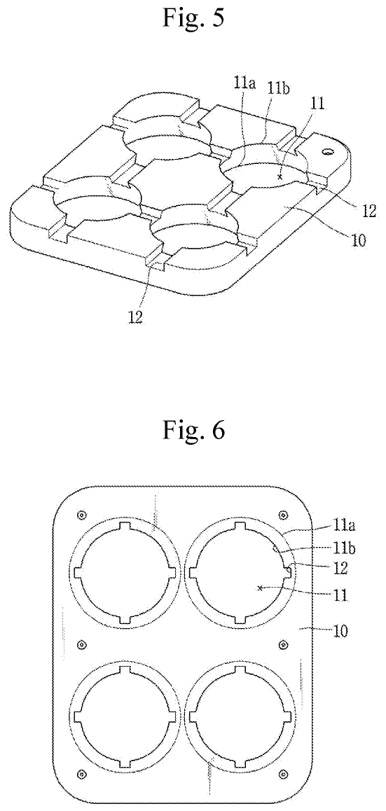

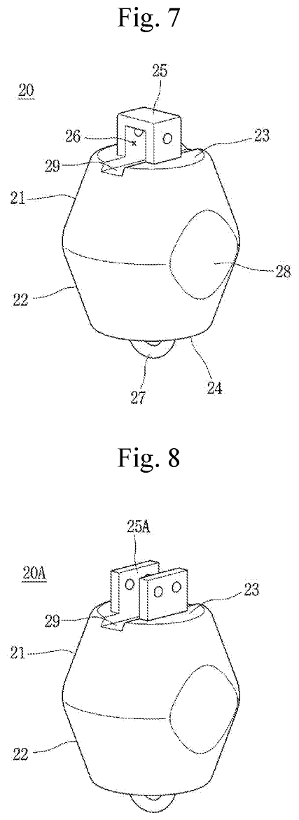

FIG. 2 is a perspective view showing a solar panel support according to an aspect of the present disclosure, FIG. 3 is a perspective view showing a buoyant body in FIG. 2, FIG. 4 is a side view of FIG. 3, FIGS. 5 and 6 are perspective and bottom plan views showing a parent buoyant body in FIG. 2, and FIG. 7 is a perspective view of a child buoyant body in FIG. 2. A solar panel support according to each embodiment of the present disclosure will be described in detail with reference to the drawings.

A solar panel support according to an aspect of the present disclosure may include a buoyant body that supports a solar panel, and the buoyant body may include a parent buoyant body 10 having a coupling hole 11 disposed to pass therethrough; and a child buoyant body 20 detachably and fittedly inserted to the coupling hole 11.

The parent buoyant body 10 may be defined in a plate shape. The parent buoyant body 10 may be defined in a flat plate, an inclined plate, a disc plate, a circular plate, or a box shape. A surrounding portion of the parent buoyant body 10 may be smoothly treated by chamfering or rounding. The parent buoyant body 10 may be formed of a synthetic resin such as PE (Polyethylene), LDPE (Low Density Polyethylene), HDPE (High Density Polyethylene). The parent buoyant body 10 may be fabricated by a molding technique such as injection molding or blow molding.

The coupling hole 11 is disposed to pass through the parent buoyant body 10. The coupling hole 11 may be disposed to pass through the parent buoyant body 10 in a vertical direction. A plurality of the coupling holes 11 are disposed. In other words, a plurality of coupling holes 11 are disposed for each unit parent buoyant body 10. The coupling hole 11 may be arranged in a matrix form. In other words, when viewed from an upper surface of the parent buoyant body 10, a plurality of coupling holes 11 may be disposed in horizontal and vertical columns, respectively. FIGS. 3, 5 and 6 illustrate an example of the parent buoyant body 10 disposed with four coupling holes in two rows and two columns.

The coupling hole 11 is defined in a tapered manner. In other words, the coupling hole 11 is disposed to have an inclined surface. Here, the coupling hole 11 is disposed to be inclined such that an upper end thereof is narrow and a lower end thereof is wide (see FIGS. 3-5). In other words, a diameter of an upper end portion 11b of the coupling hole 11 is preferably disposed to be smaller than that of a lower end portion 11a thereof. A longitudinal section of the coupling hole 11 may be made of a straight line or a curved line. FIG. 4 illustrates an example in which the longitudinal section of the coupling hole 11 is made of a straight line.

The coupling hole 11 provides a space into which the child buoyant body 20 can be inserted. An upper end portion of the child buoyant body 20 may be closely coupled to the coupling hole 11.

An upper surface of the parent buoyant body 10 may be disposed with a frame groove 12 through which a structure frame 40 can be partially inserted. The frame groove 12 may be disposed to cross a central portion of the coupling hole 11. The frame grooves 12 may be arranged in a lattice shape, that is, in horizontal and vertical directions, respectively. The frame groove 12 may be defined to have the same cross-section as the shape of the structure frame 40.

The child buoyant body 20 may be defined in a cylindrical shape. The child buoyant body 20 may be defined in a convex shape, that is, a cylindrical shape in which upper and lower portions thereof are smaller than a middle portion thereof. The upper and lower portions of the child buoyancy body 20 may be defined in a cone shape. An edge portion of the child buoyant body 20 may be smoothly treated by chamfering or rounding. The child buoyant body 20 may be formed of a synthetic resin such as PE (Polyethylene), LDPE (Low Density Polyethylene), HDPE (High Density Polyethylene). The child buoyant body 20 may be fabricated by a molding technique such as injection molding or blow molding.

The child buoyant body 20 may be bisected in a vertical direction and divided into an upper portion 21 and a lower portion 22. An upper portion 21 of the child buoyant body 20 and a lower portion 22 of the child buoyant body 20 may be disposed symmetrical to each other. The upper portion 21 and the lower portion 22 of the child buoyant body 20 are not necessarily bisected or disposed symmetrically. Here, the upper portion 21 and the lower portion 22 of the child buoyant body 20 may be divided based on a plane having the largest diameter of the middle portion. A diameter of a longitudinal middle portion of the child buoyant body 20 is defined to be larger than that of the coupling hole 11. Therefore, the child buoyant body 20 may not be separated or divided upward from the parent buoyant body 10.

The upper portion 21 of the child buoyant body 20 may be inclined to decrease in diameter upward, and the lower portion 22 of the child buoyant body 20 may be inclined to decrease in diameter downward. An upper end surface 23 and a lower surface 24 of the child buoyant body 20 may be defined in a plane.

The child buoyant body 20 is inserted into the coupling hole and coupled to the parent buoyant body 10. The child buoyant body 20 may be fittedly inserted to the coupling hole 11 from a lower end of the parent buoyant body 10 toward an upper side thereof.

The upper portion 21 of the child buoyant body 20 is inserted into the coupling hole 11 of the parent buoyant body 10. The upper end surface 23 of the child buoyant body 20 is exposed to an upper surface of the parent buoyant body 10 through the coupling hole 11. Part (lower surface portion) of the upper portion 21 of the child buoyant body 20 and the lower portion 22 of the child buoyant body 20 are exposed to a lower portion of the parent buoyant body 10.

The upper portion 21 of the child buoyant body 20 may be in close surface contact with the coupling hole 11. To this end, the upper portion 21 of the child buoyant body 20 and the coupling hole 11 are defined in a shape corresponding to each other. For an example, when the upper portion 21 of the child buoyant body 20 and the coupling hole 11 are defined in a conical shape, an inclined surface of the coupling hole 11 and an inclined surface of the upper 21 are disposed at the same inclination angle with each other. Since the child buoyant body 20 is inserted in close contact with the coupling hole 11 of the parent buoyant body 10, the child buoyant body 20 and the parent buoyant body 10 may integrally move after final coupling. In addition, water does not leak between the child buoyant body 20 and the coupling hole 11.

A diameter of the upper end surface 23 of the child buoyant body 20 may be disposed to be the same as that of the upper end portion 11 b of the coupling hole 11. Accordingly, when the child buoyant body 20 is coupled to the parent buoyant body 10, an upper surface of the parent buoyant body 10 and the upper surface (upper end surface) of the child buoyant body 20 form the same plane with each other.

A lower end surface 24 of the child buoyant body 20 may be disposed in parallel to the upper end surface 23. A diameter of the lower end surface 24 of the child buoyant body 20 may be disposed to be the same as that of the upper end surface 23.

The child buoyant body 20 may be defined in a streamlined shape. For an example, the upper portion 21 of the child buoyant body 20 is defined in a conical shape that narrows upward, and the lower portion 22 of the child buoyant body 20 is defined in a conical shape that narrows downward to receive less resistance to flow rate. As a result, it is less affected by wind or waves and remains stable.

An upper frame groove 29 connected to the frame groove 12 of the parent buoyant body 10 may be disposed at an upper portion of the child buoyant body 20. The structure frame 40 may be inserted over the frame groove 12 of the parent buoyant body 10 and the upper frame groove 29 of the child buoyant body 20.

The structure frame 40 is provided to connect a plurality of buoyant bodies 10, 20 and support the solar panel 30 and the buoyant bodies 10, 20. The structure frame 40 may be fabricated using a beam or a bar.

An upper portion of the buoyant body 20 is provided with a frame coupling portion 25 to which the structure frame 40 can be coupled. The frame coupling portion 25 may be defined in a ring shape or a ‘⊏’ shape to define a frame insertion hole 26. The frame coupling portion 25 may be provided adjacent to the upper frame groove 29. The frame coupling portion 25 may be provided by connecting to the upper frame groove 29. A width of the frame insertion hole 26 may be disposed to have the same width of the upper frame groove 29.

The structure frame 40 may be inserted into the frame insertion hole 26 to support the child buoyant body 20 and the parent buoyant body 10 and connect each of the buoyant bodies 10, 20. The structure frame 40 is inserted into the frame insertion hole 26 and the upper frame groove 29 to support the child buoyant body 20 and the parent buoyant body 10 and each buoyant body 10, 20. The child buoyant body 20 is supported by the structure frame 40 not to be released from the parent buoyant body 10.

The structure frame 40 may be fixed to the frame coupling portion 25 by screwing or the like.

The lower end surface 24 of the child buoyant body 20 may be provided with a handle 27. Accordingly, the operator may easily lift and carry the child the buoyant body 20 to perform work. When the child buoyant body 20 is coupled to the parent buoyant body 10, the operation of inserting the child buoyant body 20 into a lower portion of the parent buoyant body 10 is mainly performed, and thus the handle 27 is preferably provided on a lower surface of the child buoyant body 20.

A cutout portion 28 is disposed at a side portion of the child buoyant body 20 to reduce space. Accordingly, when a plurality of child buoyant bodies 20 are disposed adjacent to each other, the occupied space may be reduced (see FIG. 3). Accordingly, the occupancy of the buoyant body filled per unit space may increase. This is to compensate for a decrease of buoyancy caused by a streamlined shape of the child buoyant body 20. Here, the cutout portion 28 may be disposed as a surface perpendicular to the upper end surface 23.

FIG. 8 illustrates a child buoyant body 20A according to another embodiment of the present disclosure. In the present embodiment, the frame coupling portion 25 provided on the upper end surface 23 is disposed differently from the previous embodiment. In this embodiment, a straight or ‘└’-shaped frame coupling portion 25A is provided. In this embodiment, the structure frame 40 may be inserted into the frame coupling portion 25A in a vertical direction as well as in a horizontal direction.

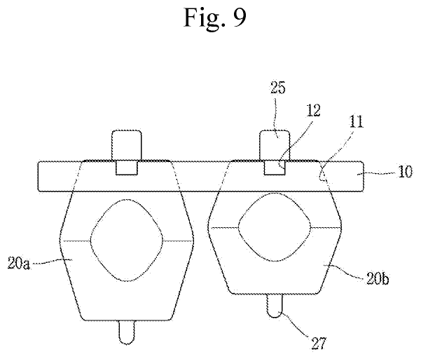

FIG. 9 illustrates a buoyant body applied to a solar panel support according to another embodiment of the present disclosure. In this embodiment, the parent buoyant body 10 is defined in the same manner as the previous embodiment. However, a plurality of child buoyant body 20 having different sizes may be provided. In other words, a first child buoyant body 20a may be defined to have a larger size than a second child buoyant body 20b. Accordingly, the first child buoyant body 20a may exhibit a greater buoyancy than the second child buoyant body 20b. In this case, when the buoyant body is floated on the water surface, the parent buoyant body 10 has a predetermined inclination angle in a horizontal direction. Therefore, the solar panel 30 may be installed with a predetermined inclination in a horizontal direction. In addition, this embodiment may be flexibly applied in spaces requiring different buoyancies. For example, although not separately illustrated, a buoyant body that supports a solar panel and a buoyant body supporting another solar panel may be configured with child buoyant bodies having different sizes to exhibit different buoyancies. For example, in consideration of the influence of waves, buoyant bodies that support the solar panel in a certain direction or a certain portion may be configured to have different buoyancies. In addition, when the solar panel support constitutes a single group, the child buoyant body provided at an outer edge portion may have a larger size than the child buoyant body disposed in the center. The buoyancy of the outer edge portion is allowed to be larger than that of the central portion, thereby having more stable maintenance.

According to a solar panel support according to each embodiment of the present disclosure, a buoyant body may be divided into a parent buoyant body and a plurality of child buoyant bodies inserted and coupled thereto, thereby facilitating maintenance work. In other words, when part of the buoyant body, for example, any child buoyant body, is damaged or destroyed, only the child buoyancy body that needs to be replaced may be selectively replaced.

Since the buoyant body is divided into a parent buoyant body and a plurality of child buoyant bodies coupled thereto, the buoyancy and supporting force are also divided to maintain a certain degree of buoyancy and supporting force even when there is damage to part thereof. In addition, an additional support structure for compensating for retentivity may not be required during maintenance work, thereby allowing simple and easy maintenance work.

The child buoyant body is defined in a streamlined shape to receive less resistance to wind or water. Accordingly, the buoyant body may maintain a stable posture.

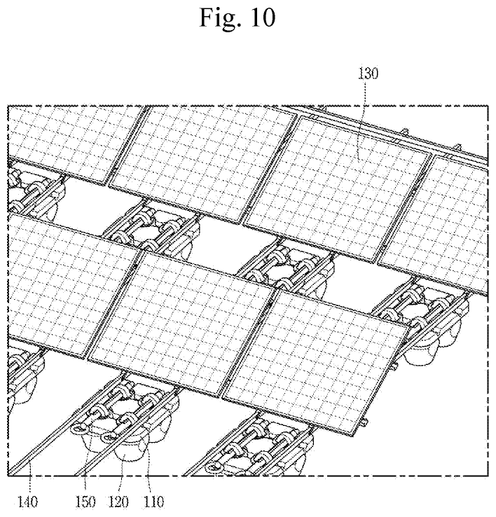

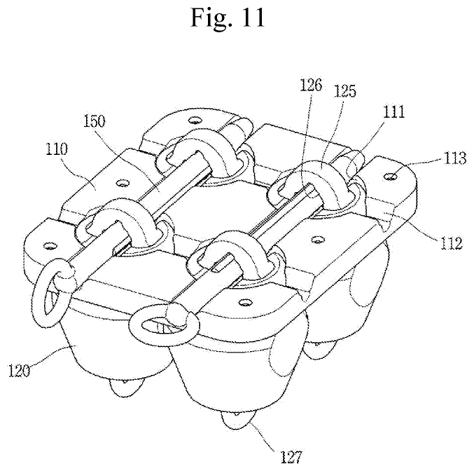

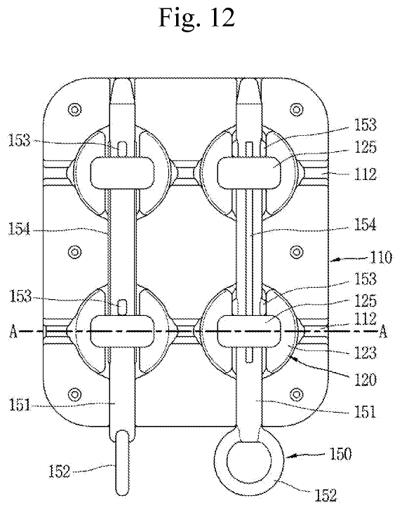

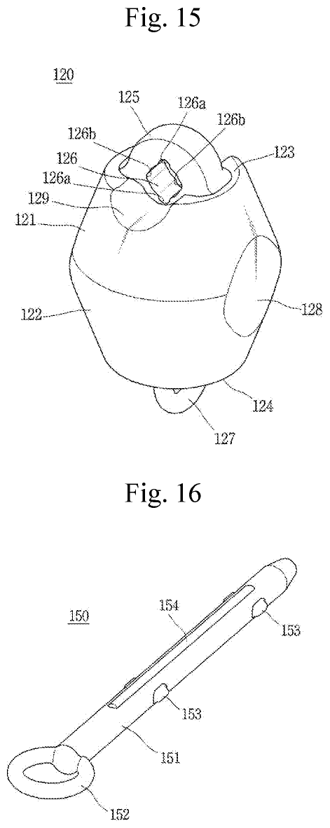

FIG. 10 is a perspective view showing a solar panel support according to another aspect of the present disclosure, FIGS. 11 through 14 are perspective and plan views showing a buoyant body in FIG. 11, a cross-sectional view taken along line A-A, and an exploded perspective view of FIG. 12, and FIGS. 15 and 16 are perspective views showing a child buoyant body and a fastening member. A solar panel support according to each embodiment of the present disclosure will be described in detail with reference to the drawings.

A solar panel support according to another aspect of the present disclosure may include a buoyant body that supports a solar panel 130, and the buoyant body may include a parent buoyant body 110 having a plurality of coupling holes 111 disposed to pass therethrough; a plurality of child buoyant bodies 120 detachably coupled to the coupling holes 111, respectively, and a fastening member 150 that fixes and supports the child buoyant bodies 120 to the parent buoyant body 110.

The parent buoyant body 110 may be defined in a plate shape. The parent buoyant body 110 may be defined in a flat plate, an inclined plate, a disc plate, a circular plate, or a box shape. A surrounding portion of the parent buoyant body 110 may be smoothly treated by chamfering or rounding. The parent buoyant body 110 may be formed of a synthetic resin such as PE (Polyethylene), LDPE (Low Density Polyethylene), HDPE (High Density Polyethylene). The parent buoyant body 110 may be fabricated by a molding technique such as injection molding or blow molding.

The coupling hole 111 is disposed to pass through the parent buoyant body 110. The coupling hole 111 may be disposed to pass through the parent buoyant body 110 in a vertical direction. A plurality of the coupling holes 111 are disposed. In other words, a plurality of coupling holes 111 are disposed for each unit parent buoyant body 110. The coupling hole 111 may be arranged in a matrix form. In other words, when viewed from an upper surface of the parent buoyant body 110, a plurality of coupling holes 111 may be disposed in horizontal and vertical columns, respectively.

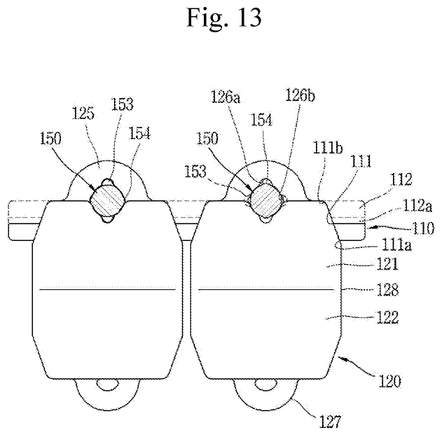

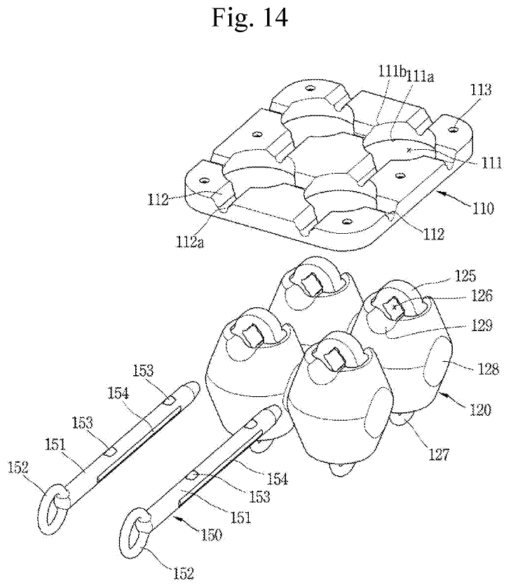

The coupling hole 111 is defined in a tapered manner. In other words, the coupling hole 111 is disposed to have an inclined surface. Here, the coupling hole 111 is disposed to be inclined such that an upper end thereof is narrow and a lower end thereof is wide (see FIGS. 13 and 14). In other words, a diameter of an upper end portion 111b of the coupling hole 111 is preferably disposed to be smaller than that of a lower end portion 111a thereof. The inclined surface may be made of a straight line or a curved line. FIG. 13 illustrates a shape in which a side surface of the coupling hole 111 is made of a straight line on a longitudinal section.

The coupling hole 111 provides a space into which the child buoyant body 120 can be inserted. An upper end portion of the child buoyant body 120 may be closely coupled to the coupling hole 111.

A mounting groove 112 in which a fastening member 150 can be installed (placed) may be disposed on an upper surface of the parent buoyant body 110. The mounting groove 112 may be disposed to cross a central portion of the coupling hole 111. The mounting groove 112 may be defined in a grid shape, that is, in horizontal and vertical directions, respectively.

The mounting groove 112 is disposed with a first moving groove 112a allowing a restraining portion 153 of the fastening member 150 to move along a longitudinal direction. The first moving groove 112a may be disposed to cross a central portion of the coupling hole 111.

A plurality of frame fastening grooves 113 (or fastening holes) to which the structure frame 140 can be coupled may be disposed on an upper surface of the parent buoyant body 110. The frame fastening groove 113 may be provided between the mounting grooves 112. A plurality of parent buoyant bodies 110 are connected and supported by the structure frame 140.

The child buoyant body 120 may be defined in a cylindrical shape. The child buoyant body 120 may be defined in a convex shape, that is, a cylindrical shape in which upper and lower end portions thereof are smaller than a middle portion thereof. The upper and lower portions of the child buoyancy body 120 may be defined in a cone shape. An edge portion of the child buoyant body 120 may be smoothly treated by chamfering or rounding. The child buoyant body 120 may be formed of a synthetic resin such as PE (Polyethylene), LDPE (Low Density Polyethylene), HDPE (High Density Polyethylene). The child buoyant body 120 may be fabricated by a molding technique such as injection molding or blow molding.

The child buoyant body 120 may be bisected in a vertical direction and divided into an upper portion 121 and a lower portion 122. An upper portion 121 of the child buoyant body 120 and a lower portion 122 of the child buoyant body 120 may be disposed symmetrical to each other. Here, the upper portion 121 and the lower portion 122 of the child buoyant body 120 may be divided based on a plane having the largest diameter of the middle portion. However, the upper portion 121 and the lower portion 122 of the child buoyant body 120 are not necessarily bisected or disposed symmetrically.

The upper portion 121 of the child buoyant body 120 may be inclined to decrease in diameter upward, and the lower portion 122 of the child buoyant body 120 may be inclined to decrease in diameter downward. An upper end surface 123 and a lower surface 124 of the child buoyant body 120 may be defined in a plane.

The upper portion 121 of the child buoyant body 120 is inserted into the coupling hole 111 of the parent buoyant body 110. The upper end surface 123 of the child buoyant body 120 is exposed to an upper surface of the parent buoyant body 110 through the coupling hole 111. Part (lower surface portion) of the upper portion 121 of the child buoyant body 120 and the lower portion 122 of the child buoyant body 120 are exposed to a lower portion of the parent buoyant body 110.

The upper portion 121 of the child buoyant body 120 may be in close contact with the coupling hole 111. To this end, the upper portion 121 of the child buoyant body 120 and the coupling hole 111 are defined in a shape corresponding to each other. For an example, when the upper portion 121 of the child buoyant body 20 and the coupling hole 111 are defined in a conical shape, an inclined surface of the coupling hole 111 and an inclined surface of the upper 121 are disposed at the same inclination angle with each other. Since the child buoyant body 120 is inserted in close contact with the coupling hole 111 of the parent buoyant body 110, the child buoyant body 120 and the parent buoyant body 110 may integrally move after final coupling.

A diameter of the upper end surface 123 of the child buoyant body 120 may be disposed to be the same as that of the upper end portion 111b of the coupling hole 111. Accordingly, when the child buoyant body 120 is coupled to the parent buoyant body 110, an upper surface of the parent buoyant body 110 and the upper surface (upper end surface) of the child buoyant body 120 form the same plane with each other.

A lower end surface 124 of the child buoyant body 120 may be disposed in parallel to the upper end surface 123. A diameter of the lower end surface 124 of the child buoyant body 120 may be disposed to be the same as that of the upper end surface 123.

The child buoyant body 120 may be defined in a streamlined shape. For an example, the upper portion 121 of the child buoyant body 120 is defined in a conical shape that narrows upward, and the lower portion 122 of the child buoyant body 120 is defined in a conical shape that narrows downward to receive less resistance to flow rate. As a result, it is less affected by wind or waves and remains stable.

A receiving groove 129 may be disposed on an upper portion of the child buoyant body 120 to provide a space in which the fastening member 150 can be mounted. The fastening member 150 may enter through the receiving groove 129.

An upper portion of the child buoyant body 120 is provided with a fastening member coupling portion 125 to which the fastening member 150 can be coupled. The fastening member coupling portion 125 may be disposed to protrude in a disk or plate shape. An insertion hole 126 may be disposed in the fastening member coupling portion 125. Accordingly, the fastening member coupling portion 125 may have a ring shape. The fastening member coupling portion 125 may be provided adjacent to the receiving groove 129. When viewed from the front, part of the insertion hole 126 may exist in the receiving groove 129.

The insertion hole 126 is disposed at a width capable of accommodating the fastening member 150. The insertion hole 126 may be defined in a substantially circular longitudinal section. In the insertion hole 126, a second moving groove 126a allowing the restraining portion 153 of the fastening member 150 to move is disposed on upper and lower surfaces thereof, and restricting grooves 126b allowing an engaging portion 154 of the fastening member 150 to move are disposed on left and right surfaces thereof. The second moving groove 126a is defined to be larger than the restricting groove 126b. The second moving groove 126a may be defined with the same diameter as the first moving groove 112a.

The second moving groove 126a is defined with a size allowing the restraining portion 153 and the engaging portion 154 of the fastening member 150 to pass therethrough. In other words, a diameter of the second moving groove 126a is defined to be larger than that of the restraining portion 153 and that of the engaging portion 154. (A diameter used in this specification to denote a size for a groove indicates a diameter of a virtual circle defined on a transverse section of the relevant groove.)

The restricting groove 126b is defined in a size that passes through the engaging portion 154 but does not pass through the restraining portion 153. In other words, a diameter of the restricting groove 126b is defined to be larger than that of the engaging portion 154, but to be smaller than that of the restraining portion 153.

The lower end surface 124 of the child buoyant body 120 may be provided with a handle 127. Accordingly, the operator may easily lift and carry the child the buoyant body 120 to perform work. When the child buoyant body 120 is coupled to the parent buoyant body 110, the operation of inserting the child buoyant body 120 into a lower portion of the parent buoyant body 110 is mainly performed, and thus the handle 127 is preferably provided on a lower surface of the child buoyant body 120.

A cutout portion 128 is disposed at a side portion of the child buoyant body 120 to reduce space. Accordingly, when a plurality of child buoyant bodies 120 are disposed adjacent to each other, the occupied space may be reduced (see FIG. 11). Accordingly, the occupancy of the buoyant body filled per unit space may increase. This is to compensate for a decrease of buoyancy caused by a streamlined shape of the child buoyant body 120. Here, the cutout portion 128 may be disposed as a surface perpendicular to the upper end surface 123.

The fastening member 150 is provided to couple the parent buoyant body 110 and the child buoyant body 120 to each other. The fastening member 150 may be inserted into the insertion hole 126 of the child buoyant body 120, and installed in a manner supported on an upper surface of the parent buoyant body 110.

The fastening member 150 may include a body rod 151 inserted into the fastening member coupling portion 125 of the child buoyant body 120, and a handle portion 152 provided at one end portion of the body rod and disposed on a front surface of the parent buoyant body 110.

The restraining portion 153 is disposed to protrude on the body rod 151. The restraining portion 153 may be inserted (may move) through the first moving groove 112a of the parent buoyant body 110 and the second moving groove 126a of the child buoyant body 120. The restraining portion 153 is used as a device for restricting the movement of the fastening member 150. In other words, when mounted or released, the restraining portion 153 moves through the second moving groove 126a of the child buoyant body 120 while being placed in a vertical direction, and in a normal state, the restraining portion 153 is placed in a horizontal direction and caught on a rear surface of the fastening member coupling portion 125 to restrain the fastening member 150 from moving forward.

The engaging portion 154 is disposed to protrude on the body rod 151 to be spaced apart from the restraining portion 153. The engaging portion 154 may move through the restricting groove 126b of the fastening member coupling portion 125.

The restraining portion 153 and the engaging portion 154 may be disposed to be spaced apart from each other by 90 degrees based on a longitudinal axis of the body rod 151.

A diameter of the engaging portion 154 is defined to be smaller than the restricting groove 126b to allow the engaging portion 154 to freely move through restricting groove 126b and the second moving groove 126a.

The operation of the fastening member 150 will be described as follows.

First, the process of coupling the child buoyant body 120 to the parent buoyant body 110 using the fastening member 150 will be described as follows.

While the child buoyant body 120 is in close contact with the coupling hole 111 of the parent buoyant body 110, the fastening member 150 is inserted into the insertion hole 126 of the child buoyant body 120. At this time, the fastening member 150 is moved while the restraining portion 153 is placed in a vertical direction (the fastening member shown on the left side of FIGS. 11 through 13). At this time, the restraining portion 153 of the fastening member 150 is moved through the first moving groove 112a of the parent buoyant body 110 and the second moving groove 126a of the child buoyant body 120.

The fastening member 150 is pushed in until the handle portion 152 of the fastening member 150 is brought into contact with a front surface of the parent buoyant body 110. At this time, the restraining portion 153 of the fastening member 150 is placed at a position that has passed the second moving groove 126a, that is, a position that has passed the fastening member coupling portion 125.

The fastening member 150 is rotated by a predetermined angle (e.g., a separation angle between the restraining portion and the engaging portion) with the handle portion 152 based on a longitudinal axis to place the restraining portion 153 in a horizontal direction (the fastening member shown on the right side of FIGS. 11 through 13). The restraining portion 153 is placed behind the restricting groove 126b, and the restricting groove 126b is placed at the position of the second moving groove 126a. Unless external force is applied, the fastening member 150 is not rotated by the engaging portion 154 based on the longitudinal axis. In addition, the fastening member 150 does not move in a front-rear direction by the handle portion 152 and the restraining portion 153. In a normal state, the fastening member 150 stably maintains coupling between the parent buoyant body 110 and the child buoyant body 120.

When the child buoyant body 120 is separated from the parent buoyant body 110, the fastening portion is rotated and separated such that the restraining portion 153 of the fastening member 150 faces in a vertical direction by applying an external force (for example, a manual force of an operator) similarly to the case of mounting.

A structure frame 140 is provided to connect a plurality of buoyant bodies 110, 20 and support the solar panel 130 and the buoyant bodies 110, 20. The structure frame 140 may be fabricated using a beam or a bar. The structure frame 140 may be fastened to the frame fastening groove 113 disposed on an upper surface of the parent buoyant body 110. The plurality of buoyant bodies 110, 20 are connected to each other and supported by the structure frame 140.

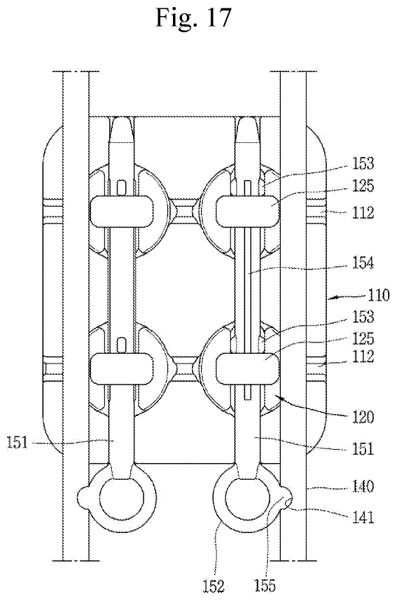

FIG. 17 illustrates a solar panel support according to another embodiment of the present disclosure. In this embodiment, the locking portion 155 is protruded from the handle portion 152 of the fastening member 150, and a locking groove 141 is disposed in the structure frame 140, and the locking portion 155 is fittedly inserted thereto. Accordingly, the fastening member 150 is also coupled to the structure frame 140 to increase the stability of coupling. When the handle portion 152 is rotated, the lock portion 155 is released from the lock groove 141 to cancel the restraint.

Although not separately shown, the fastening member 150 may be fastened to the parent buoyant body 110 in a transverse direction as well as in a longitudinal direction. When the fastening member 150 is mounted in a transverse direction, it may be made by installing the fastening portion 150 in the mounting groove 112 disposed in a transverse direction (horizontal direction) among the mounting grooves 112 of the parent buoyant body 110.

Furthermore, a direction in which the handle portion 152 of the fastening member 150 is located may also be changed. The handle portion 152 may be disposed toward an outside of the solar panel 130 or may be disposed toward an inside thereof. The ease of maintenance will be a major consideration in determining this arrangement.

In addition, a configuration of the restraining portion and the locking portion protruded from the fastening member, and the moving groove and the restricting groove disposed on the child buoyant body to correspond thereto, on the contrary, may be configured in such a manner that the restraining portion and the locking portion in a groove shape are disposed in the fastening member, and a protruding portion corresponding thereto is disposed on the child buoyant body.

According to a solar panel support according to each embodiment of the present disclosure, a buoyant body may be divided into a parent buoyant body and a plurality of child buoyant bodies inserted and coupled thereto, thereby facilitating maintenance work. In other words, when part of the buoyant body, for example, any child buoyant body, is damaged or destroyed, only the child buoyancy body that needs to be replaced may be selectively replaced.

The parent buoyant body and the child buoyant body may be stably supported because they are coupled to each other by a fastening member. They are easily detachable. Here, they are easily detachable since the fastening member is defined in a pin type. Therefore, maintenance work may be conveniently carried out. In addition, the fastening member may be disposed with a locking portion and thus not separated in a normal state.

Since the buoyant body is divided into a parent buoyant body and a plurality of child buoyant bodies coupled thereto, the buoyancy and supporting force are also divided to maintain a certain degree of buoyancy and supporting force even when there is damage to part thereof. In addition, an additional support structure for compensating for retentivity may not be required during maintenance work, thereby allowing simple and easy maintenance work.

The child buoyant body is defined in a streamlined shape to receive less resistance to wind or water. Accordingly, the buoyant body may maintain a stable posture.

The embodiments described above are embodiments for implementing the present disclosure. Accordingly, it should be noted that the embodiments disclosed in the present invention are only illustrative and not limitative to the concept of the present invention, and the scope of the concept of the invention is not limited by those embodiments. In other words, the scope protected by the present disclosure should be construed by the accompanying claims, and all the technical concept within the equivalent scope of the invention should be construed to be included in the scope of the right of the present disclosure.

1. A solar panel support, comprising:
a buoyant body that supports the solar panel, wherein the buoyant body comprises a parent buoyant body having a coupling hole disposed to pass therethrough; and
a child buoyant body detachably and fittedly inserted to the coupling hole.

2. The solar panel support of claim 1, wherein a plurality of the coupling holes are arranged in vertical and horizontal directions, and the child buoyant bodies are coupled to the coupling holes, respectively.

3. The solar panel support of claim 1, wherein the child buoyant body is fittedly inserted to the coupling hole from a lower end of the parent buoyant body in an upward direction.

4. The solar panel support of claim 1, wherein an upper surface of the child buoyant body is exposed to an upper surface of the parent buoyant body through the coupling hole, and a lower portion of the child buoyant body is exposed to a lower surface of the parent buoyant body.

5. The solar panel support of claim 1, wherein the coupling hole is tapered in a shape that narrows upward.

6. The solar panel support of claim 5, wherein an upper portion of the child buoyant body is inclined in a direction of decreasing upward, and a lower portion of the child buoyant body is inclined in a direction of decreasing downward.

7. The solar panel support of claim 6, wherein a diameter of a middle portion of the child buoyant body is defined to be larger than that of the coupling hole.

8. The solar panel support of claim 6, wherein an upper portion of the child buoyant body is disposed to be in close surface contact with the coupling hole.

9. The solar panel support of claim 1, wherein a frame coupling portion to which a structure frame connecting and supporting a plurality of buoyant bodies is coupled is disposed at an upper portion of the child buoyant body.

10. The solar panel support of claim 9, wherein the frame coupling portion is defined in a ring shape.

11. The solar panel support of claim 1, wherein a handle is provided at a lower portion of the child buoyant body.

12. The solar panel support of claim 1, wherein a cutout portion is disposed at a side portion of the child buoyant body to reduce space.

13. The solar panel support of claim 2, wherein child buoyant bodies coupled to the plurality of coupling holes, respectively, are defined in different sizes.

14. The solar panel support of claim 13, wherein the plurality of child buoyant bodies are defined such that a size of the child buoyant body disposed at an outer edge portion is larger than that of the child buoyant body disposed at the center portion.

15. A solar panel support, comprising:
a buoyant body that supports a solar panel, wherein the buoyant body comprises a parent buoyant body having at least one coupling hole disposed to pass therethrough;
a plurality of child buoyant bodies detachably coupled to the coupling holes, respectively; and
a fastening member that fixes and supports the child buoyant bodies to the parent buoyant body.

16. The solar panel support of claim 15, wherein a mounting groove in which the fastening member is installed is disposed in the parent buoyant body.

17. The solar panel support of claim 16, wherein a fastening member coupling portion is disposed to protrude from an upper portion of the child buoyant body, and an insertion hole is disposed in the fastening member coupling portion to allow the fastening member to be fittedly inserted to the insertion hole.

18. The solar panel support of claim 17, wherein the fastening member comprises a body rod inserted into the insertion hole and a handle portion provided at an end portion of the body rod.

19. The solar panel support of claim 18, wherein a restraining portion is disposed to protrude from the body rod.

20. The solar panel support of claim 19, wherein a first moving groove and a second moving groove allowing the restraining portion to move are disposed in the mounting groove and the insertion hole, respectively.

21. The solar panel support of claim 20, wherein an engaging portion is disposed to protrude on the body rod to be spaced apart from the restraining portion.

22. The solar panel support of claim 21, wherein a diameter of the engaging portion is defined to be smaller than that of the restraining portion.

23. The solar panel support of claim 22, wherein a restricting groove having a diameter smaller than that of the restraining portion and a diameter larger than that of the engaging portion is disposed in the insertion hole.

24. The solar panel support of claim 21, wherein the restraining portion and the engaging portion are spaced apart from each other by 90 degrees based on a longitudinal axis of the body rod.

25. The solar panel support of claim 19, wherein the restraining portion is disposed to be placed behind the fastening member coupling portion in a normal state.
